(19) United States
(12) Patent Application Publication
(10) Pub. No.: US 2008/0107366 A1
(43) Pub. Date: May 8, 2008

(54) Air fan bearing structure

(75) Inventors: Ching-Hung Huang, Taipei County (TW); Chih-Tsung Kao, Taipei County (TW)

Correspondence Address: BIRCH STEWART KOLASCH & BIRCH, PO BOX 747, FALLS CHURCH, VA, 22040-0747, US

(73) Assignee: ZIPPY TECHNOLOGY CORP.

(21) Appl. No.: 11/593,117

(22) Filed: Nov. 6, 2006

(51) Int. Cl. F16C 32/06

(52) U.S. Cl. 384/107

(57) ABSTRACT

An improved air fan bearing structure includes a bearing on an air fan and a spindle located in the bearing. The bearing has an inner periphery in contact with the spindle that forms a first air chamber and a second air chamber of different cross section areas. The first air chamber contains a lubricant which has an oil film tension greater than the internal static pressure of the second air chamber. Thus the spindle can be positioned by the internal static pressure and the oil film tension. When the spindle rotates, according to Bernoulli's Law, there is a pressure difference between the first air chamber and the second air chamber to squeeze the lubricant to the second air chamber to form an oil film. Hence the spindle can be supported and rotated without touching the bearing to reduce run out.

### FIELD OF THE INVENTION

The present invention relates to an improved air fan bearing structure and particularly to a bearing structure for holding and lubricating an air fan spindle.

### BACKGROUND OF THE INVENTION

Bearing is a mechanical element to support the weight of a spindle and direct the motion of the spindle. The spindle has a spindle neck braced by the bearing. Friction occurs between the spindle neck and the bearing that causes a lot of power loss and damage of the bearing. Hence reducing friction is an important issue in the research and development of the bearing. All the stresses generated by the spindle are born by the bearing, hence the bearing must have sufficient strength and lubrication.

There are many types of bearings. They mainly can be divided into ball bearings, liquid bearings and ceramic bearings. Ball bearings are most commonly used. They usually have respectively eight to twelve steel balls to support the weight of a motor. Once rotation starts, friction occurs on the metal surface. Run out incurs to the steel balls during rotation. This phenomenon is more severe as the speed of the motor increases, and becomes the bottleneck of ball bearing utilization.

The liquid bearing differs from the ball bearing mainly by using an oil film to replace the steel balls. Referring to FIG. 1, a conventional bearing 11 has a layer of oil film on the inner periphery to enable the spindle I to rotate smoothly and does work on a vane 4 on another end. The ideal liquid bearing supports the spindle 1 without direct contact, hence theoretically does not have run out problem. Therefore the liquid bearing can absorb vibration better than the ball bearing, and has a lower run out. But to achieve the ideal “Zero run out” condition, lubricants and lubrication mechanism have to be improved constantly R.O.C. Patent Publication No. 505208 entitled “Improved oil contained bearing” discloses a bearing which has a hollow housing chamber to hold a piece of oil absorbing sponge to contain lubrication oil to lubricate the rotating spindle. While it can provide desired lubrication in the center, lubrication effect on the contact surface between two ends of the bearing and the spindle drops significantly. R.O.C. Patent Publication No. 350495 entitled “Oil storage structure for bearings” has a bearing, a bushing and a latch bolt to form an oil storage space to hold a greater amount of lubrication oil that can be replenished frequently. While it can store sufficient amount of oil, it does not have a distribution mechanism to evenly distribute the lubrication oil. Thus uneven run out occurs. Run out of contact surface between the bearing and spindle takes place after using a long period of time. Not only operation effect diminishes, noise also is being generated. It becomes dysfunctional when the run out is excessive. And the life span is shortened. Fabrication cost also is higher. Hence how to maintain sufficient and even lubrication for bearings is an important issue in bearing design.

### SUMMARY OF THE INVENTION

Therefore the primary object of the present invention is to provide a bearing structure that can evenly distribute lubricant on the bearing, reduce run out of the bearing and spindle and minimize noise and vibration.

The bearing structure of the invention includes at least two first air chambers carving on an inner periphery of the bearing, and a second air chamber formed in a gap between a spindle and the range of a distal end of the first air chambers and a lower edge of the bearing. The cross section area of the first air chamber is greater than that of the second air chamber. Based on Bernoulli's Law, the sum of pressure, dynamic energy and potential energy is a constant. Hence during rotation of the bearing airflow speed difference generates a pressure difference to push a lubricant stored in the first air chamber to the second air chamber. The first air chamber is communicated with an external chamber through a groove. Thus even if the bearing rotates at a low speed, atmosphere pressure can push the lubricant to the second air chamber.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a conventional bearing.

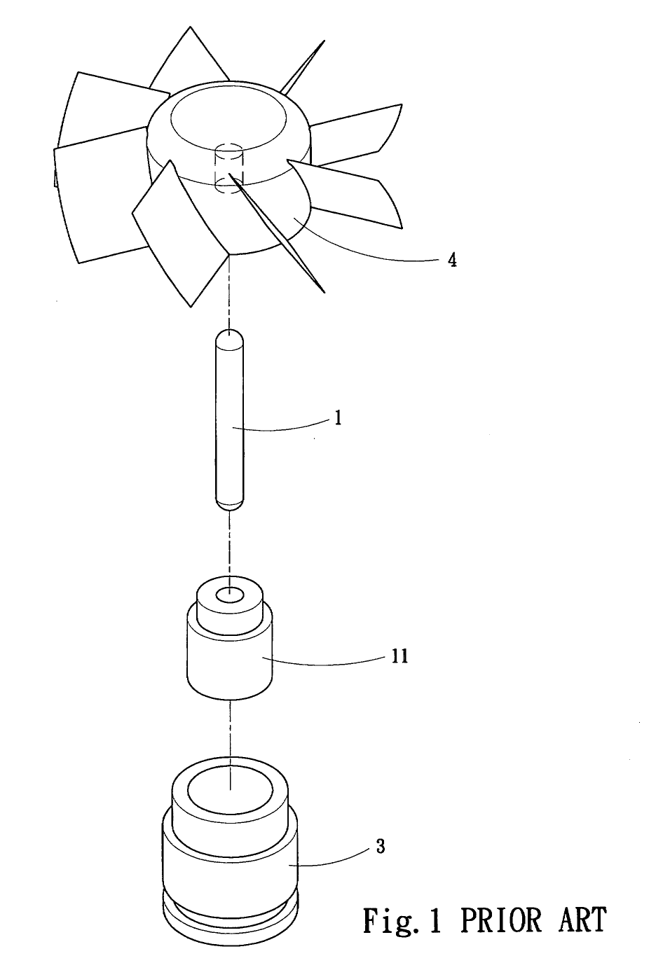

FIG. 2 is an exploded view of an embodiment of the invention.

FIG. 3 is a sectional view of an embodiment of the invention.

FIG. 4 is a top view of an embodiment of the invention.

FIG. 5 is a bottom view of an embodiment of the invention.

FIG. 6 is an exploded view of another embodiment of the invention.

FIG. 7 is a sectional view of another embodiment of the invention.

### DETAILED DESCRIPTION OF THE PREFERRED EMBODIMENTS

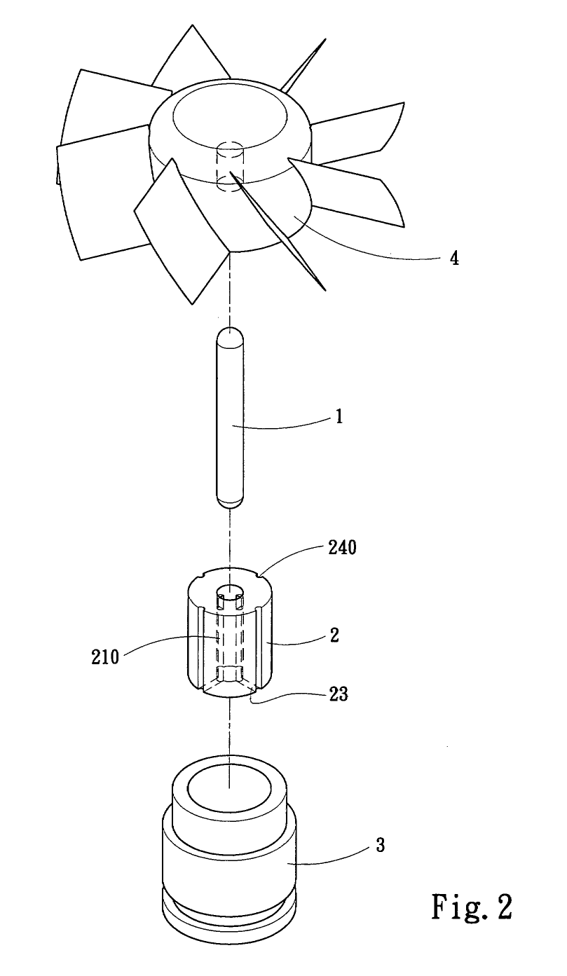

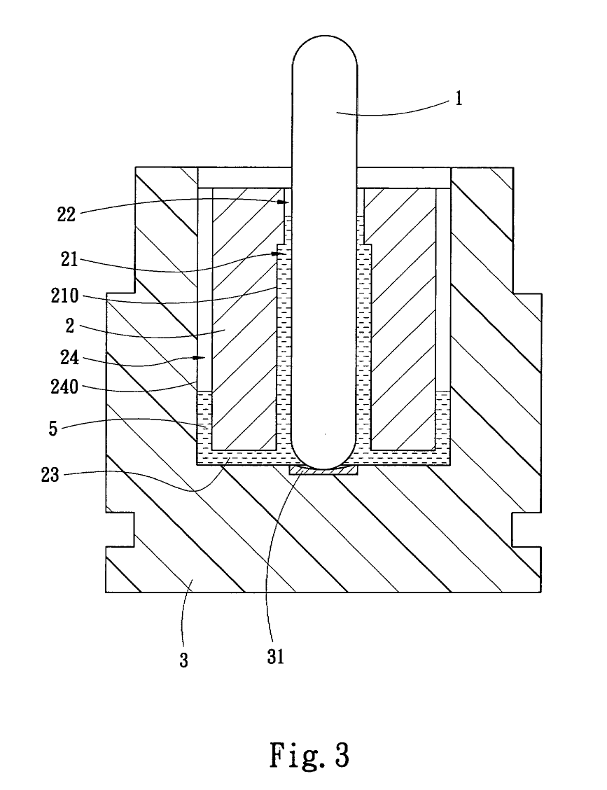

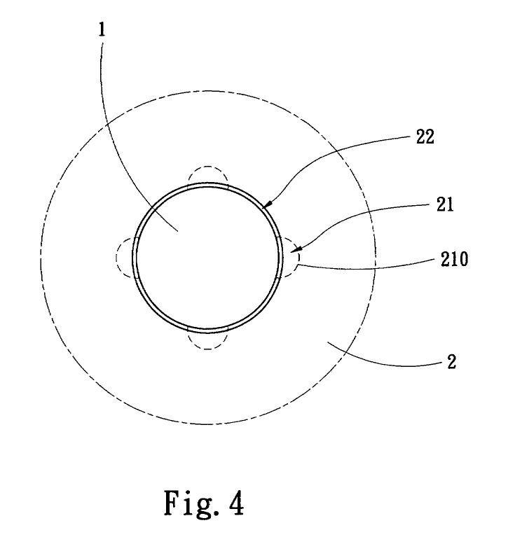

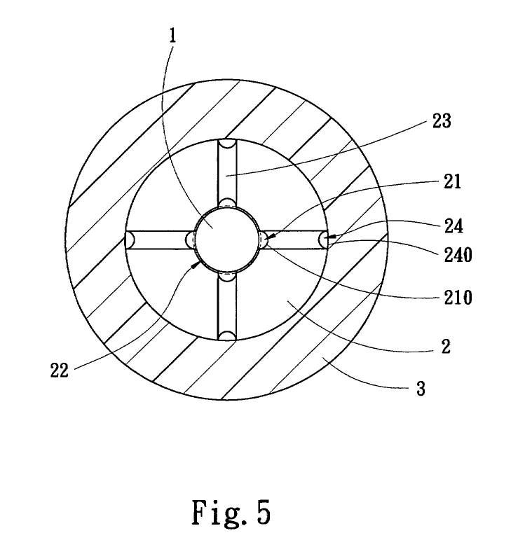

Please refer to FIGS. 2 through 5, the air fan bearing structure according to the invention aims to reduce friction during rotation of a spindle 1 to achieve higher working efficiency. It includes a bearing 2 which holds the spindle 1 inside. The spindle 1 has one end fastened to a vane 4 and another end coupled with the bearing 2. The bearing 2 has an inner periphery in contact with the spindle 1 that forms at least a first air chamber 21 and a second air chamber 22 that have different cross section areas. The first air chamber 21 includes a plurality of first carving ditches 210 which are equally spaced from one another and extended from one end surface of the inner periphery towards other end without reaching another end surface. The second air chamber 22 is formed by the allowance between the spindle 1 and the searing 2. The invention further has a bushing 3 to hold the bearing 2. The first air chamber 21 of a greater cross section area is encased in the bushing 3. At least the first air chamber 21 contains a lubricant 5 which has an oil film tension greater than the internal static pressure of the second air chamber 22. The spindle 1 held in the bearing 2 can be positioned due to the oil film tension of the first air chamber 21 and the internal static pressure of the second air chamber 22. Moreover, between the spindle 1 and the second air chamber 22, and the bearing 2 and the bushing 3, an airtight condition is formed to become a natural oil seal so that the lubricant 5 does not flow out due to atmosphere pressure to prevent loss of the lubricant 5.

According to Bernoulli's Law, the sum of pressure, dynamic energy and potential energy is a constant. And dynamic energy is direct proportional with the square of flow speed. Hence the smaller the airflow speed passing through the air chamber, the greater the pressure difference becomes. Because of the different cross section areas of the first and second air chambers 21 and 22 formed between the bearing 2 and the spindle 1, when the spindle 1 receives a force and rotates, flow speed through the first air chamber 21 is slower than that of the second air chamber 22 due to its greater cross section area. As a result, the pressure in the first air chamber 21 is greater than that of the second air chamber 22. The pressure difference between the first air chamber 21 and the second air chamber 22 forces the lubricant 5 to be squeezed through the tangent surface to become an oil film apex so that the spindle 1 can be rotated and supported by the oil film of a great tension without touching the bearing 2. The spindle 1 is extended to the bottom of the bushing 3 which has a wearing-resistant pad 31 located on the bottom to form a point contact with one end of the spindle 1. Thus friction loss can be reduced.

In addition, considering the spindle 1 at a low rotation speed and the initial positioning condition in which the fluid speed is not yet great enough to fully generate the oil film, and contact of the spindle 1 and the bearing 2 could occur and result in run out, the invention also provides a third air chamber 24 between the outer periphery of the bearing 2 and the bushing 3, or has a plurality of second carving ditches 240 formed on the outer periphery of the bearing 2 to boost the pressure difference of the third air chamber 24 and the first air chamber 21. The second carving ditches 240 also are evenly spaced on the outer periphery of the bearing 2. The third air chamber 24 and the first air chamber 21 are communicated through a plurality of grooves 23. The third air chamber 24 also leads to the exterior. Thus the external atmosphere pressure can boost the pressure difference to generate the oil film during initial operation of the spindle 1 to achieve a steady positioning effect.

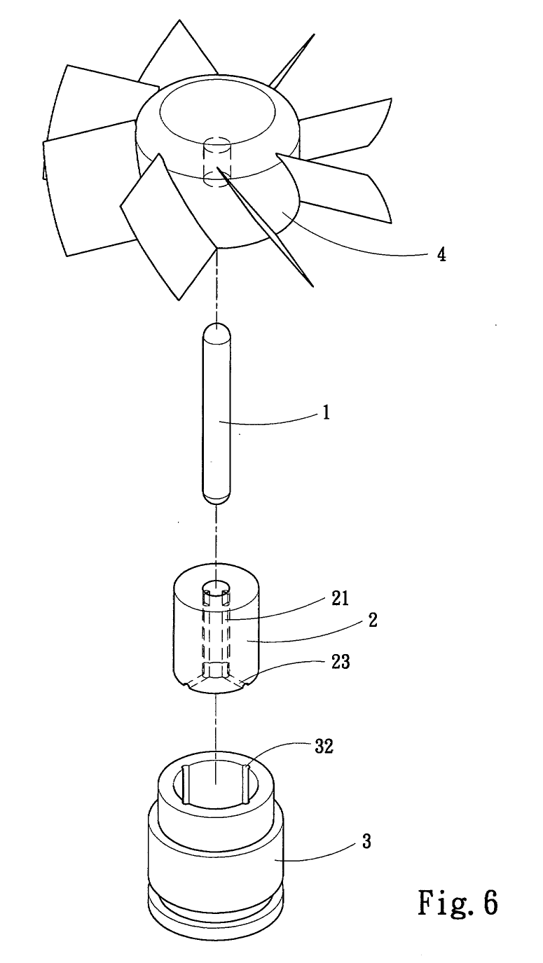

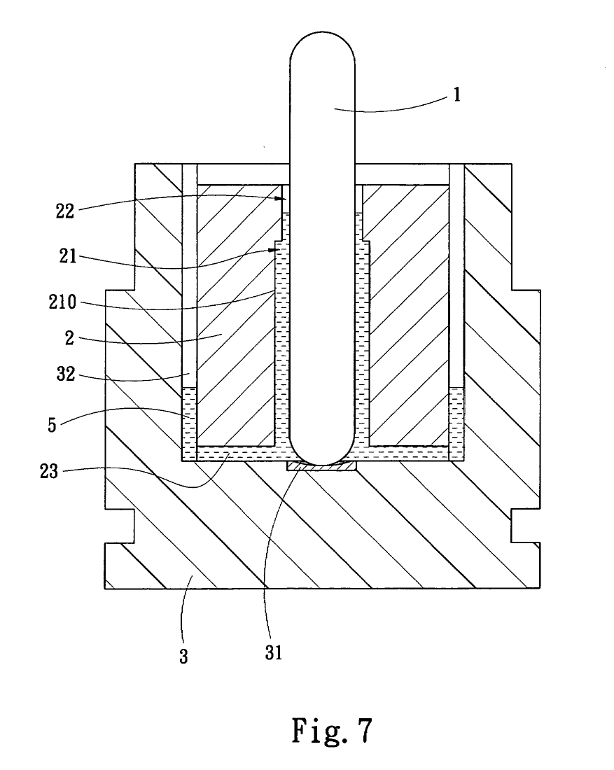

The second carving ditches 240 to boost the pressure difference between the third air chamber 24 and the first air chamber 21 are not necessary to be formed on the outer periphery of the bearing 2. Any schemes that communicate the external air with the first air chamber 21 can be adopted. They also may be formed on the vane 4 or bushing 3. FIGS. 6 and 7 illustrate another embodiment in which a plurality of third carving ditches 32 for boosting the pressure difference of the third air chamber 24 and the first air chamber 21 are formed on an inner periphery of the bushing 3. They also can achieve the function of squeezing the lubricant 5 through the atmosphere pressure to get desired lubrication for the spindle 1 and the bearing 2.

In short, the invention provides the following benefits:
1. The lubricant 5 is squeezed by the pressure difference so that it can be evenly distributed.
2. The oil film of the lubricant 5 is evenly distributed in the second air chamber 22 so that there is almost no contact between the spindle 1 and the bearing 2, and run out can be prevented.
3. As airtight is formed between the spindle 1 and the second air chamber 22, and between the bearing 2 and the bushing 3, the lubricant 5 does not flow out under the atmosphere pressure, and a natural oil seal is formed. Loss of the lubricant 5 can be prevented. A greater oil film pressure is generated during operation to protect the bearing 2.
4. The invention is constructed simpler than the conventional ones, and can reduce cost and increase production speed.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An air fan bearing structure, comprising:
a bearing; and
a spindle located in the bearing;
wherein the bearing has an inner periphery in contact with the spindle that has at least a first air chamber and a second air chamber of different cross section areas, the bearing being encased by a bushing to seal the first air chamber of a greater cross section area, at least the first air chamber containing a lubricant which has an oil film tension greater than the internal static pressure of the second air chamber so that the spindle held in the bearing is positioned through the internal static pressure of the second air chamber and the oil film tension of the lubricant of the first air chamber; when the spindle is rotating under a force the first air chamber and the second air chamber have a pressure difference to squeeze the lubricant to the second air chamber to form an oil film so that the rotation of the spindle is supported without touching the bearing to reduce run out.

2. The air fan bearing structure of claim 1, wherein the second air chamber is formed by the allowance between the spindle and the bearing.

3. The air fan bearing structure of claim 1, wherein the first air chamber is formed by a first carving ditch which is located on the inner periphery of the bearing extending from one end surface towards another end without reaching another end surface.

4. The air fan bearing structure of claim 3, wherein the first air chamber includes a plurality of first carving ditches that are formed on the inner periphery in an equally spaced manner.

5. The air fan bearing structure of claim 1 further having a third air chamber formed by the allowance between an outer periphery of the bearing and the bushing, the third air chamber communicating with the first air chamber.

6. The air fan bearing structure of claim 5, wherein the outer periphery of the bearing has a second carving ditch to boost the pressure difference of the third air chamber and the first air chamber.

7. The air fan bearing structure of claim 6, wherein the bearing has a groove to communicate the third air chamber with the first air chamber.

8. The air fan bearing structure of claim 6, wherein the third air chamber is formed by a plurality of second carving ditches that are equally spaced on the outer periphery of the bearing

9. The air fan bearing structure of claim 5, wherein the bushing has third carving ditches on an inner periphery thereof to boost the pressure difference of the third air chamber and the first air chamber.

10. The air fan bearing structure of claim 9, wherein the bearing has a groove to communicate the third air chamber with the first air chamber.

11. The air fan bearing structure of claim 10, wherein the third air chamber includes a plurality of the third carving ditches that are equally spaced on the inner periphery of the bushing.

12. The air fan bearing structure of claim 1, wherein the spindle is extended in contact with the bottom of the bushing, the bottom of the bushing having a wearing-resistant pad.
